(19) United States
(12) Patent Application Publication
(10) Pub. No.: US 2012/0174417 A1
(43) Pub. Date: Jul. 12, 2012

(54) HANDLE SYSTEM FOR GARDEN SHEARS

(75) Inventor: Yao-Chung Huang, Fu Shing Hsiang (TW)

(73) Assignee: HO CHENG GARDEN TOOLS CO., LTD., FU SHING HSIANG (TW)

(21) Appl. No.: 13/004,849

(22) Filed: Jan. 11, 2011

(51) Int. Cl. A01G 3/025

(52) U.S. Cl. 30/312

(57) ABSTRACT

Garden shears have the extended rod connected to the handle to increase the reachable length and the cutting arm length of the garden shears for various ranges. The extended rod has the containment slot for accepting the tool member and the spacer at the opening, and the insertion hole of the spacer allows the tool member to be assembled with the extended rod to create a handy tool.

### BACKGROUND OF THE INVENTION

1. Field of the Invention

The present invention relates to a handle system for garden shears, and more particularly to a handle system providing extended rods to increase the cutting arms of the garden shears and the extended rod can be assembled with stored tool members.

2. Description of the Related Art

Currently, prior art garden shears 30, please refer to FIG, 8, has two opposite blades 31 respectively pivoted onto handles 32. But the handles 32 have fixed lengths which limits the reachable range of the garden shears 30.

Therefore, it is desirable to provide a handle system for garden shears to mitigate and/or obviate the aforementioned problems.

### SUMMARY OF THE INVENTION

An objective of the present invention is to provide a handle system for garden shears, which provides extended rods to increase the cutting arms of the garden shears and the extended rod can be assembled with stored tool members.

In order to achieve the above-mentioned objectives, garden shears 10 of an embodiment of the present invention respectively have two handles, and each handle is a hollow tube body and has an axial assembling aperture at an end and a positioning aperture on a side through the handle for engaging with a corresponding securing member. The two extended rods respectively have a hollow containment slot with an opening at an end for containing at least a tool member inside. Each opening has a spacer, and two ends of each spacer respectively has an insertion portion, and each insertion portion has an insertion hole at both ends. An outer surface of each extended rod respectively forms a holding portion and assembling portion, the assembling portion has a plurality of limiting apertures.

With the above mention structure, the following benefits can be obtained:

1. Garden shears have the extended rod connected to the handle to increase the reachable length and the cutting arm length of the garden shears for various ranges.

2. The extended rod has the containment slot for accepting the tool member and the spacer at the opening, and the insertion hole of the spacer allows the tool member to be assembled with the extended rod to create a handy tool.

Other objects, advantages, and novel features of the invention will become more apparent from the following detailed description when taken in conjunction with the accompanying drawings.

### BRIEF DESCRIPTION OF THE DRAWINGS

FIG. 1 is a perspective assembly drawing of an embodiment of the present invention.

FIG. 2 is a perspective exploded drawing of the embodiment of the present invention.

FIG. 3 is a cross-sectional drawing of the embodiment of the present invention.

FIG. 4 is a cross-sectional drawing showing movements of the embodiment of the present invention.

FIG. 5 is a top view schematic drawing of the movements of the embodiment of the present invention.

FIG. 6 is a schematic drawing showing the extended rod attached to a tool member according to an embodiment of the present invention.

FIG. 7 is a schematic drawing showing the extended rod attached to a scythe according to an embodiment of the present invention.

FIG. 8 is a schematic drawing of a prior art.

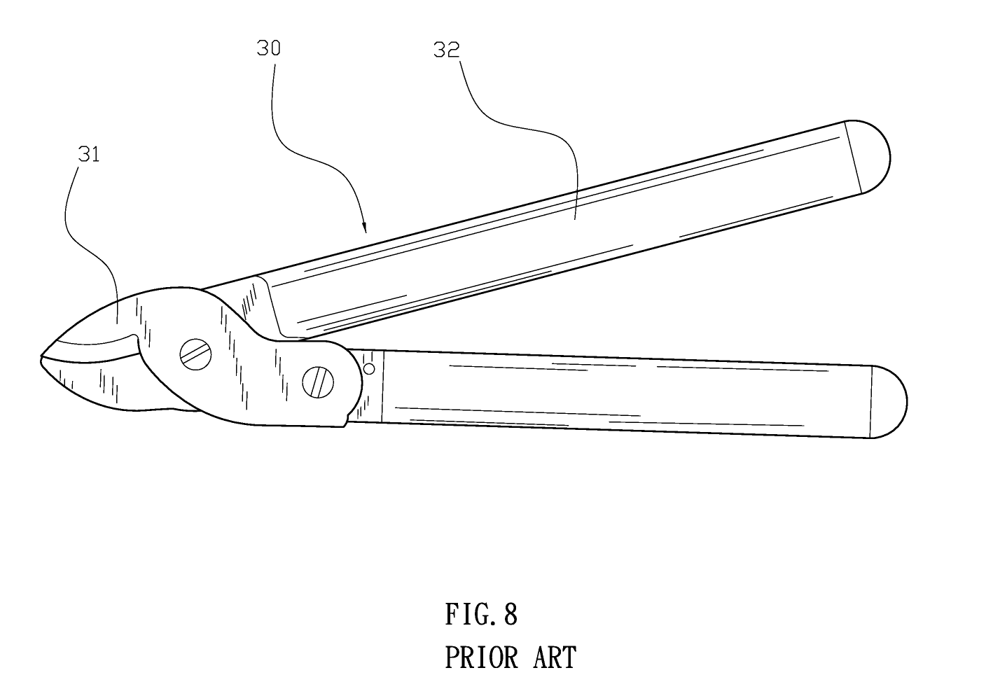

### DETAILED DESCRIPTION OF THE PREFERRED EMBODIMENT

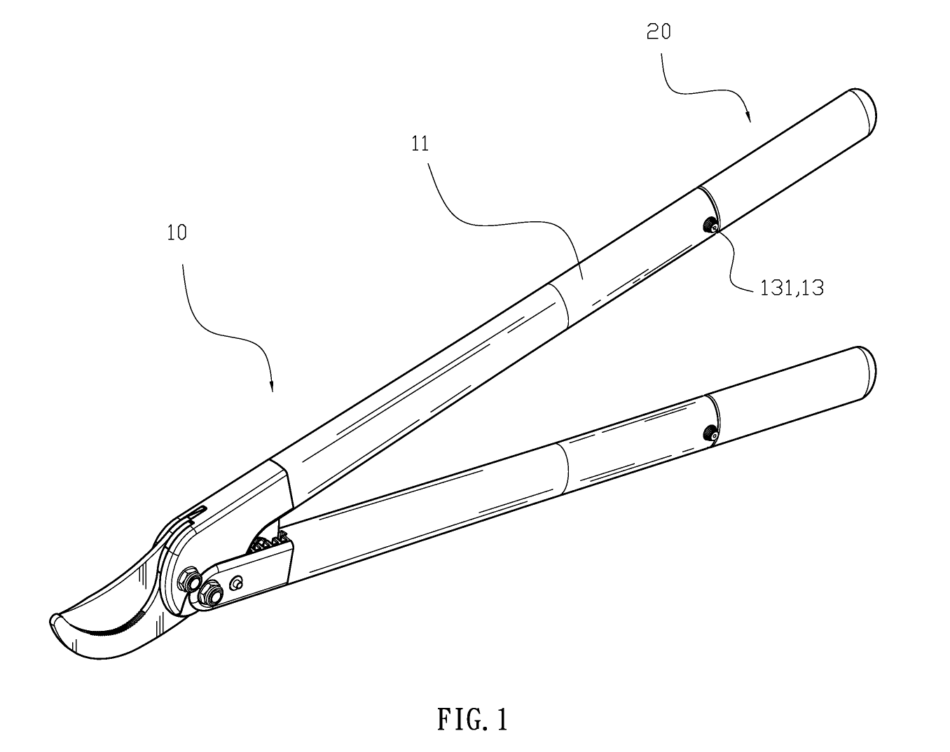

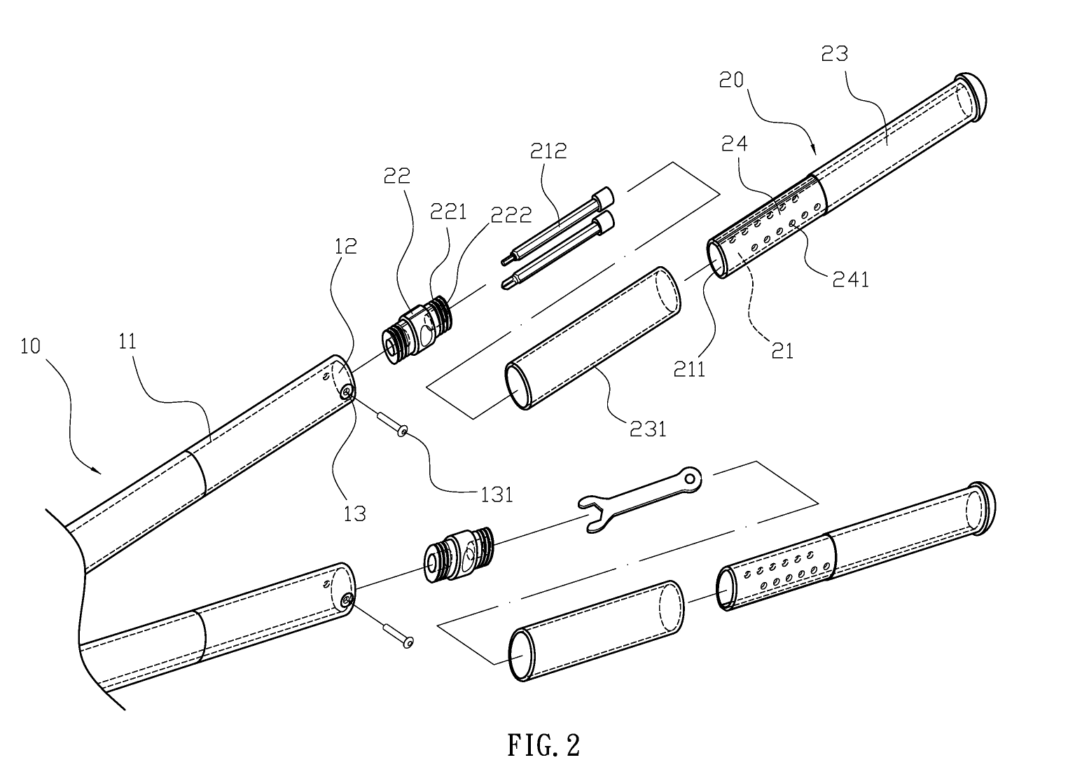

Please refer to FIG. 1 and FIG. 2. Garden shears 10 respectively have two handles 11, and each handle 11 is a hollow tube body and has an axial assembling aperture 12 at an end and a positioning aperture 13 on a side through the handle 11 for engaging with a corresponding securing member 131. The two extended rods 20 respectively have a hollow containment slot 21 with an opening 211 at an end for containing at least a tool member 212 inside. Each opening 211 has a spacer 22, and two ends of each spacer 22 respectively had an insertion portion 221, and each insertion portion 221 has an insertion hole 222 at both ends. An outer surface of each extended rod 20 respectively forms a holding portion 23 and assembling portion 24, the assembling portion 24 has a plurality of limiting apertures 241.

For assembly, please refer to FIGS. 2, 3 and 4. The assembling portion 24 of the two extended rods 20 are respectively inserted into the assembling apertures 12 of the handle 11 of the garden shears 10, and the plurality of limiting apertures 241 are disposed at the outer edge of the assembling portion 24. Therefore, different combinations using any limiting aperture 241 and positioning aperture 13 of the handle 11 pivoted together by the securing member 131 can provide different lengths for the combination of the extended rod 20 and the handle 11 of the garden shears 10. Furthermore, at least one tool member 212 can be placed in the containment slot 21 of the extended rod 20, and the spacer 22 is installed at the opening 211.

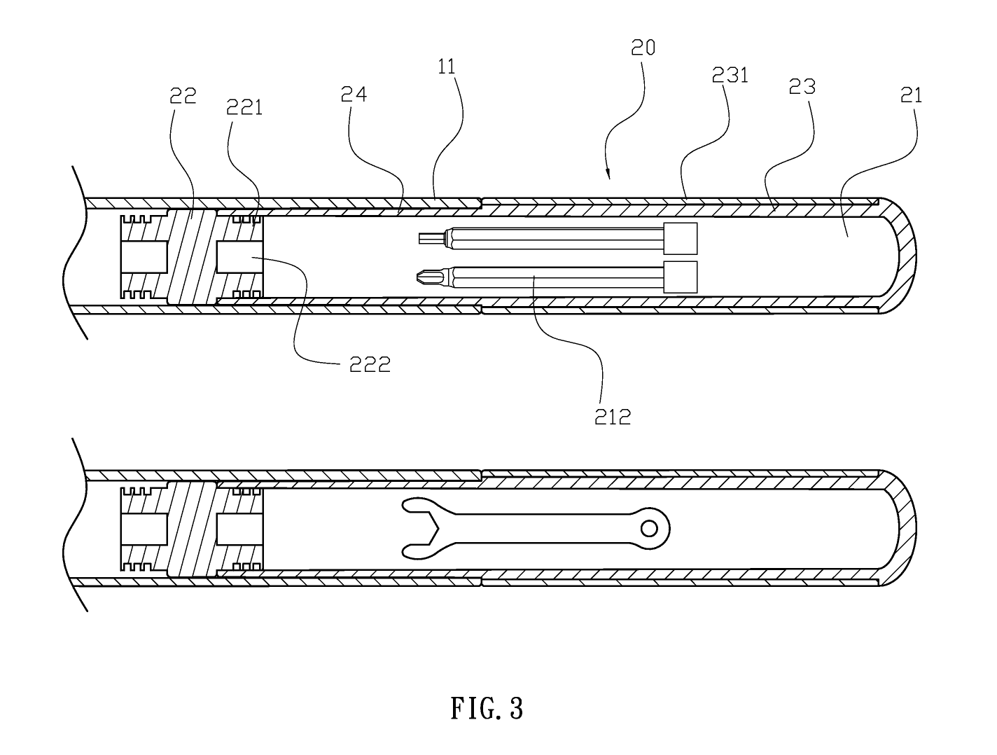

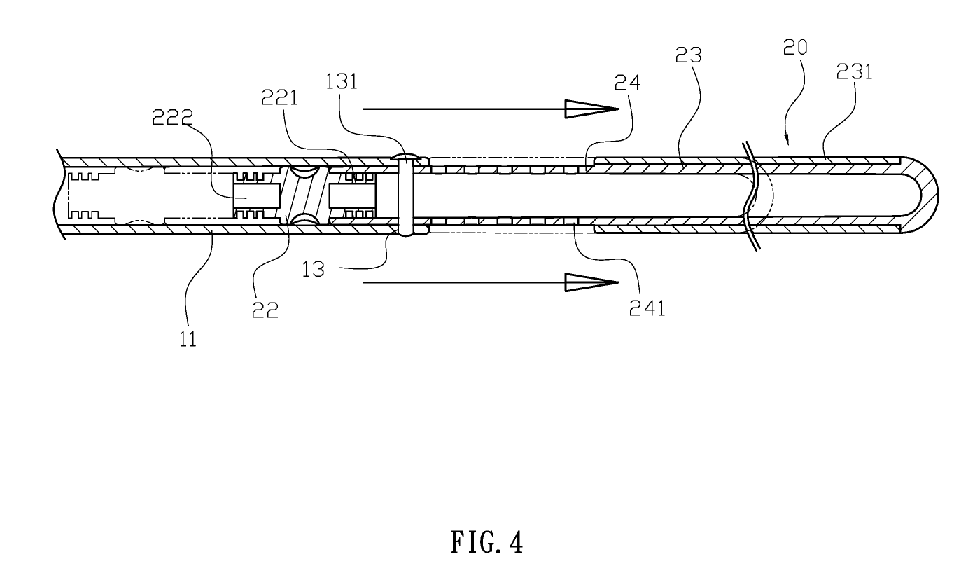

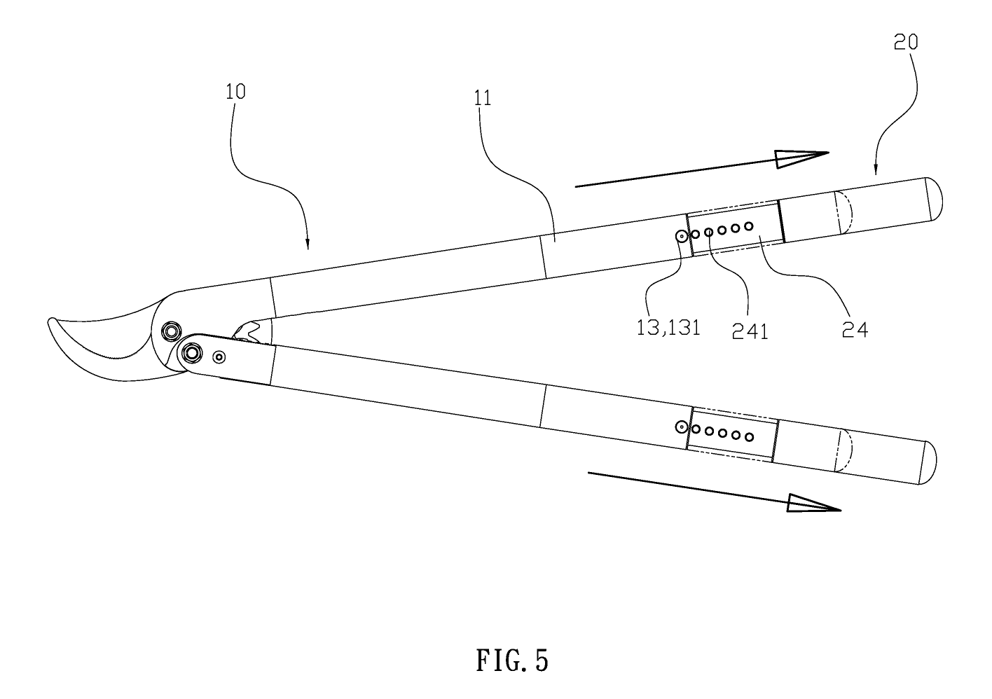

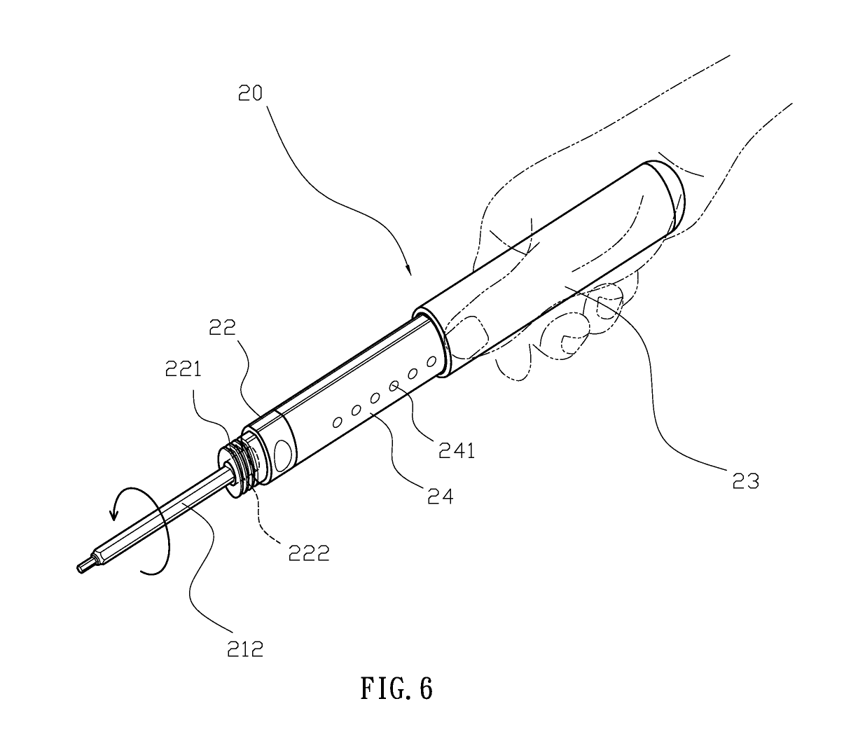

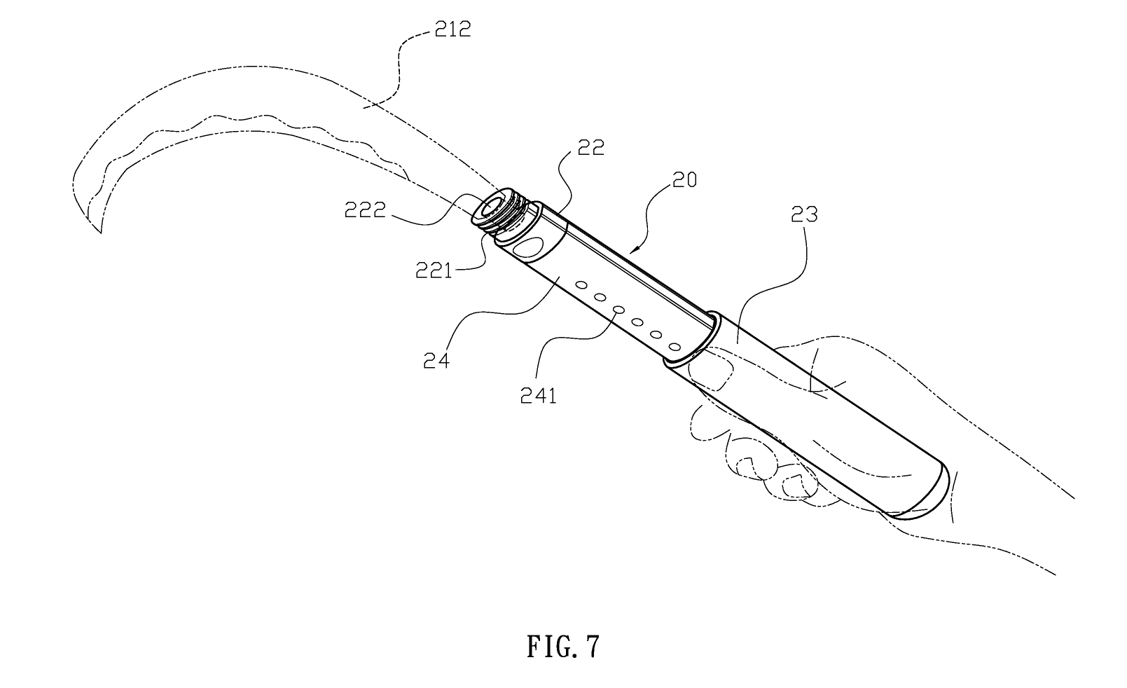

For actual operations, please refer to FIG. 4 and FIG. 5. The garden shears 10 are suitable for operation with the handle 11. When the target object is far or requires a greater cutting strength, the extended rod 20 may be inserted into the assembling aperture 12 at the end of the handle 11 with the assembling portion 24, and then the securing member 131 is placed through the positioning aperture 13 and the limiting aperture 241 to elongate the handle 11 to provide a longer cutting arm. When the extended rod 20 is detached from the handle 11 of the garden shears 10, the extended rod 20 can be directly carried around, and the containment slot 21 of the extended rod 20 is capable of accepting a plurality of tool members 212 and provides a spacer 22 to contain the tool members 212 in the containment slot 21, as shown in FIG. 3. A tool member 212 can be taken out and assembled with the insertion hole 222 of the inserting portion 221 of the spacer 22, as shown in FIG. 6, such that the extended rod 20 is utilized as a tool handle. The tool member 212 can also be a scythe, as shown in FIG. 7, or any other gardening tool, and can be directly attached to the inserting portion 221 or the insertion hole 222.

With the above mention structure, the following benefits can be obtained: 1. The garden shears 10 have the extended rod 20 connected to the handle 11 to increase the reachable length and the cutting arm length of the garden shears 10 for various ranges. 2. The extended rod 20 has the containment slot 21 for accepting the tool member 212 and the spacer 22 at the opening 211, and the insertion hole 222 of the spacer 22 allows the tool member 212 to be assembled with the extended rod 20 to create a handy tool.

Although the present invention has been explained in relation to its preferred embodiment, it is to be understood that many other possible modifications and variations can be made without departing from the spirit and scope of the invention as hereinafter claimed.

What is claimed is:

1. A handle system for garden shears, the garden shears respectively utilizing two handles, the handle system comprising:
two handles, each handle being a hollow tube body and having an axial assembling aperture at an end and a positioning aperture on a side through the handle for engaging with a corresponding securing member;
the two extended rods respectively having a hollow containment slot with an opening at an end for containing at least a tool member inside, each opening having a spacer, two ends of each spacer respectively having an insertion portion, and each insertion portion having an insertion hole at both ends; an outer surface of each extended rod respectively forming a holding portion and assembling portion, the assembling portion having a plurality of limiting apertures.

2. The handle system for garden shears as claimed in claim 1, wherein an outer diameter of each holding portion is larger than an outer diameter of the corresponding assembling portion.

3. The handle system for garden shears as claimed in claim 1, wherein each holding portion further comprises a sleeve jacketed thereon.
